(19) United States
(12) Patent Application Publication
(10) Pub. No.: US 2002/0134924 A1
(43) Pub. Date: Sep. 26, 2002

(54) Light sensor

(76) Inventor: Jun Ohshimo, Osaka (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/040,952

(22) Filed: Jan. 9, 2002

(30) Foreign Application Priority Data
Mar. 22, 2001 (JP) 2001-83598

(51) Int. Cl. G01J 1/04

(52) U.S. Cl. 250/227.11

(57) ABSTRACT

The light sensor has a plate-shaped light guide in which a plurality of reflection portions each comprising a V groove are parallelly arranged on one plane thereof. An end face of the light guide which faces the side surfaces of the V grooves is opposed to a light emitting face of a light emitter. Light receivers are disposed at an appropriate distance from the light guide so that the light receiving faces thereof are opposed to the other plane of the light guide. Light emitted from the light emitter is taken in the light guide, is reflected at the reflection portions, and is ejected from the other plane toward the light receivers. With the light sensor, the range of detection by one light emitter is large, it is easy to adjust the optical axes, and the number of provided light emitters can be reduced.

### BACKGROUND OF THE INVENTION

1. Field of the Invention

The present invention relates to a light sensor having a light emitter and a light receiver for receiving light emitted from the light emitter.

2. Description of Related Art

A light sensor having a light emitter and a light receiver is known in which the light emitter and the light receiver are disposed so as to be opposed to each other with an appropriate space in between so that the light emitted from the light emitter is received by the light receiver. The light sensor is capable of detecting entry of an object into the space between the light emitter and the light receiver or a position of an object present in the space based on the light received by the light receiver.

FIG. 1 is a perspective view showing a conventional light sensor of this kind. As shown in this figure, light emitters 11 are arranged in a vertical direction, and light receivers 12 are arranged in the vertical direction at a predetermined distance from the light emitters 11 so that each light receiver 12 is opposed to the corresponding light emitter 11. The light emitters 11 emit light toward the corresponding light receivers 12, and the light emitters 12 receive the light.

As shown in FIG. 1, such a light sensor is placed, for example, in the vicinity of a robot 13 used for processing or assembling a product, and is used for limiting the operation range of the robot 13. When the robot 13 operates so as to intercept light emitted from one or more of the light emitters 11, the light reception quantity of one or more of the light receivers 12 is largely reduced. By controlling the robot 13 so as to stop operating in response to a large reduction of the light reception quantity, the robot 13 can be prevented from operating beyond the limit defined by the light sensor.

However, in the conventional light sensor as shown in FIG. 1, it is necessary that the optical axes of the light emitters 11 substantially coincide with the optical axes of the light emitters 12. In a case where the distance between the adjoining light emitters 11 is too short, the light received by one light receiver 12 includes not only the light emitted from the light emitter 11 opposed to this light receiver 12 but also the light emitted from the light emitters 11 adjoining the opposed light emitter 11, so that the light sensor does not operate normally. In a case where the distance between the adjoining light emitters 11 is too long, when an object enters the space between the light emitted from one light emitter 11 and the light emitted from an adjoining light emitter 11, entry of the object cannot be detected by the light receivers 12 opposed to these light emitters 11, so that the light sensor does not operate normally. Consequently, placement of the light sensor requires much time and trouble.

When the optical axes of the light emitters 11 and the optical axes of the light receivers 12 are shifted from each other with time, a maintenance and management cost is required for adjusting the shift. On the other hand, to prevent the optical axes from shifting from each other, a cost for placement is required.

To increase the range of detection by one pair of a light emitter 11 and a light receiver 12, there are cases where in a light sensor, light emitters 11 from which light is emitted so as to be diverged are employed and a convex lens is interposed between the light emitters 11 and the light receivers 12. In this light sensor, light emitted from each light emitter 11 so as to be diverged is converged by the convex lens, and the corresponding light receiver 12 receives the converged light. However, in this case, since an expensive convex lens is required, the cost significantly increases.

FIG. 2 is a perspective view showing another conventional light sensor. FIG. 2 shows a light sensor in which a vertically elongated bar-shaped light emitter 21 and a light receiver 22 having a vertically elongated light receiving portion shorter than the light emitter 21 are opposed to each other. As shown in FIG. 2, such a light sensor is used for winding control, for example, when a belt-shaped object 23 is wound up at a constant tension. The light sensor is placed below the object 23 partly hanging down in a V shape. The quantity of light emitted from the light emitter 21 and intercepted by the hanging part of the object 23 is obtained from the quantity of light received by the light receiver 22. By controlling the winding speed of the object 23 so that the hanging part moves up and down based on the quantity of the intercepted light, the object 23 can be wound up at a constant tension.

However, in the conventional light sensor as shown in FIG. 2, since the bar-shaped light emitter 21 is expensive, the cost is high.

To increase the detection range, there are cases where in a light sensor, a plurality of light emitters 21 are parallelly arranged and a plurality of light receivers 22 are parallelly arranged so as to be respectively opposed to the light emitters 21. In this case, however, to prevent interference of light between the adjoining light emitters 21, a complicated control is required such that each light emitter 21 is controlled so as to blink at a different frequency and each light receiver 22 is controlled so as to detect only the light with the same frequency as the light emitted from the light emitter 21 opposed to the receiver 22.

FIG. 3 is a perspective view showing still another conventional light sensor. In FIG. 3, a plurality of light emitters 31 are arranged in a line, and a plurality of light receivers 32 are arranged in a line parallel to the line of the light emitters 31 so that the light receiving faces of the light receivers 32 face in the same direction as the light emitting faces of the light emitters 31. Such a light sensor is, for example, attached to a conveyer vehicle (not shown) used for conveying articles in a factory or a warehouse.

Onto the floor of the factory or the warehouse, a reflective tape is bonded along the conveyance path of the conveyer vehicle. The light emitted from one of the light emitters 31 which is opposed to the reflective tape is reflected at the reflective tape, and the reflected light is received by one of the light receivers 32 which adjoins the light emitter 31. Since the light reception quantity of this light receiver 32 is much larger than the light reception quantities of the other light receivers 32, it can be detected which light receiver 32 is opposed to the reflective tape. Therefore, for example, by controlling the conveyer vehicle so as to run with the same light receiver 32 always opposed to the reflective tape, the conveyer vehicle can be driven without deviating from the conveyance path.

However, in the conventional light sensor as shown in FIG. 3, since the light emitted from each light emitter 31 is reflected and the reflected light is received by the corresponding light receiver 32, it is necessary to arrange the light emitters 31 and the light receivers 32 so that the optical axis of each reflected light and the optical axis of the corresponding light receiver 32 substantially coincide with each other. Consequently, placement of the light sensor requires much time and trouble.

### BRIEF SUMMARY OF THE INVENTION

The present invention has been made with the aim of solving the above problems, and an object thereof is to provide a light sensor in which it is easy to make the optical axes coincide with each other, the optical axes do not readily shift from each other even when the position of the light emitter or the light receiver shifts with time, and time and trouble required for placement can be significantly reduced compared with the conventional light sensors.

Another object of the present invention is to provide a light sensor in which the cost is low compared with the conventional light sensors because the range of detection by one light emitter can be increased, this enables reduction of the number of provided light emitters and no convex lens is required.

Still another object of the present invention is to provide a light sensor requiring only a small space for placing a light guide.

Still another object of the present invention is to provide a light sensor in which the intensity of the light ejected from one plane of a light guide can be made substantially uniform over the entire area of the plane.

Still another object of the present invention is to provide a light sensor in which light can be ejected substantially parallelly from a light guide.

A light sensor according to the present invention comprises: a light emitter; a light receiver for receiving light emitted from the light emitter; and a light guide for taking in the light emitted from the light emitter, reflecting the taken-in light at a reflection portion provided on a part thereof, and ejecting the light toward the light receiver. The light receiver and the light guide are disposed so as to be opposed to each other with an appropriate space in between. The light sensor is capable of detecting entry of an object into the space based on the light received by the light receiver.

In the light sensor, the light guide ejects the light emitted from the light emitter so that the luminous flux is diverged. Consequently, the optical axes can be easily made to coincide with each other only by disposing the light receiver so as to be opposed to the part of the light guide from which the light is ejected, the optical axes do not readily shift from each other even when the position of the light emitter or the light receiver shifts with time, and time and trouble required for placement can be significantly reduced compared with the conventional light sensors.

Moreover, in the light sensor, by the light emitted from the light emitter being ejected by the light guide, the light emitted from one light emitter can be ejected in a wide range to thereby increase the range of detection by the light emitter. Consequently, the number of provided light emitters can be reduced, no convex lens is required, and the cost can be reduced compared with the conventional light sensors.

In the light sensor according to the present invention, the light guide has a plate shape, and has the reflection portion disposed on one plane thereof. The light guide takes in the light through one end face thereof, reflects the taken-in light at the reflection portion, and ejects the reflected light from the other plane thereof. Since light emitted from one light emitter can be ejected in a wide range, the range of detection by one light emitter can be increased.

Moreover, it is facilitated to make the optical axes coincide with each other by disposing the light emitter and the end face of the light guide so as to be opposed to each other or by bonding the light emitter and the end face together, so that the maintenance and management cost of the optical axis adjustment can be reduced.

Furthermore, since the light guide has a plate shape, only a small space for placement is required.

In the light sensor according to the present invention, the reflection portion has a groove shape. In the light sensor, the light taken in the light guide is reflected at the side surfaces of the grooves, and the reflected light is ejected. Consequently, by inclining the side surfaces of the grooves at an appropriate angle, the light can be ejected substantially parallelly from the light guide. Moreover, by arranging the grooves so as to be spaced at a predetermined distance, the light can be ejected substantially uniformly from the entire area of one plane of the light guide.

Another light sensor according to the present invention comprises: a light emitter; and a light receiver for receiving light emitted from the light emitter and reflected at a reflective object, and detects a position of the reflective object based on the light received by the light receiver. The light sensor further comprises a light guide for taking in the light emitted from the light emitter, reflecting the taken-in light at a reflection portion provided on a part thereof, and ejecting the light. The light receiver is capable of receiving the light ejected from the light guide and reflected at the reflective object.

In this light sensor, since the light emitted from the light emitter is ejected by the light guide, the range in which the light is applied can be increased compared with a case where the light is applied to the reflective object without passing through the light guide. Consequently, it is easy to dispose the light receiver so as to receive the light reflected at the reflective object, the optical axes can be easily made to coincide with each other, the optical axes do not readily shift from each other even when the position of the light emitter or the light receiver shifts with time, and time and trouble required for placement can be significantly reduced compared with the conventional light sensors.

Moreover, by the light emitted from the light emitter being ejected by the light guide so that the luminous flux is diverged, the range in which the light emitted from one light emitter is applied to the reflective object can be increased. Consequently, the number of provided light emitters can be reduced.

Still another light sensor according to the present invention comprises: a light emitter; a light receiver for receiving light emitted from the light emitter; and a light guide for taking in the light emitted from the light emitter, reflecting the taken-in light at a reflection portion provided on a part thereof, and ejecting the light toward the light receiver. The light emitter and the light guide are disposed so as to be opposed to each other with an appropriate space in between. The light sensor is capable of detecting entry of an object into the space based on the light received by the light receiver.

In this light sensor, the light emitted from the light emitter is taken in the light guide, and the taken-in light is ejected from the light guide. Consequently, the optical axes can be easily made to coincide with each other only by disposing the light emitter so as to be opposed to the part of the light guide through which the light is taken in, the optical axes do not readily shift from each other even when the position of the light emitter or the light receiver shifts with time, and time and trouble required for placement can be significantly reduced compared with the conventional light sensors.

This light sensor is structured so that by the light guide taking in the light emitted from the light emitter and ejecting the taken-in light, the light emitted from one or more of the light emitters in a wide range is taken into the light guide, and the taken-in light is reflected at the reflection portion and ejected toward one light receiver. Thus, the range of detection by the light receiver can be increased. Consequently, the number of provided light receivers can be reduced, no convex lens is required, and the cost can be reduced compared with the conventional light sensors.

Still another light sensor according to the present invention comprises: a light emitter; a light receiver for receiving light emitted from the light emitter; a first light guide for taking in the light emitted from the light emitter, reflecting the taken-in light at a reflection portion provided on a part thereof, and ejecting the light; and a second light guide for taking in the light ejected from the first guiding body, reflecting the taken-in light at a reflection portion provided on a part thereof, and ejecting the light toward the light receiver. The first light guide and the second light guide are disposed so as to be opposed to each other with an appropriate space in between. Consequently, entry of an object into the space can be detected based on the light received by the light receiver.

In this light sensor, light emitted from the light emitter is ejected by the first light guide, the ejected light is taken in the second light guide, and the taken-in light is ejected toward the light receiver. Consequently, the optical axes can be easily made to coincide with each other only by disposing the part of the first light guide from which the light is ejected and the part of the second light guide through which the light is taken in so as to be opposed to each other, the optical axes do not readily shift from each other even when the position of the light emitter or the light receiver shifts with time, and time and trouble required for placement can be significantly reduced compared with the conventional light sensors.

Moreover, by the light emitted from the light emitter being ejected by the first light guide, the light emitted from one light emitter can be ejected in a wide range to thereby increase the range of detection by the light emitter. Furthermore, by the light thus ejected being taken in the second light guide, reflected at the reflection portion of the second light guide and ejected toward one light receiver, the range of detection by the light receiver can be increased. Consequently, the number of provided light emitters and light receivers can be reduced, no convex lens is required, and the cost can be reduced compared with the conventional light sensors.

The above and further objects and features of the invention will more fully be apparent from the following detailed description with accompanying drawings.

### BRIEF DESCRIPTION OF THE SEVERAL VIEWS OF THE DRAWINGS

FIG. 1 is a perspective view showing a conventional light sensor;

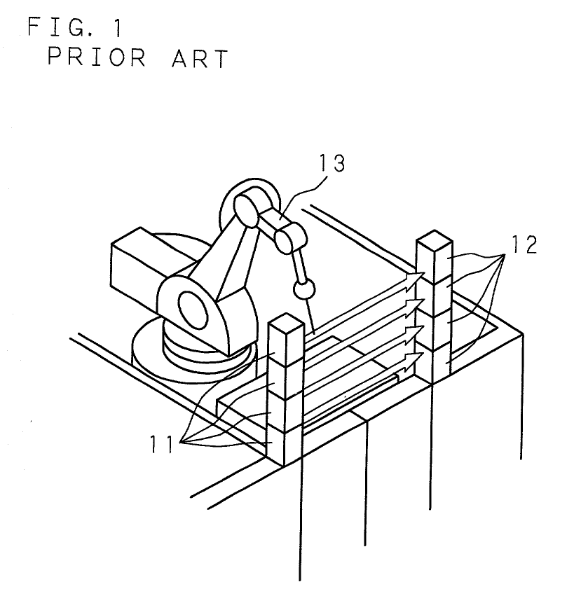

FIG. 2 is a perspective view showing another conventional light sensor;

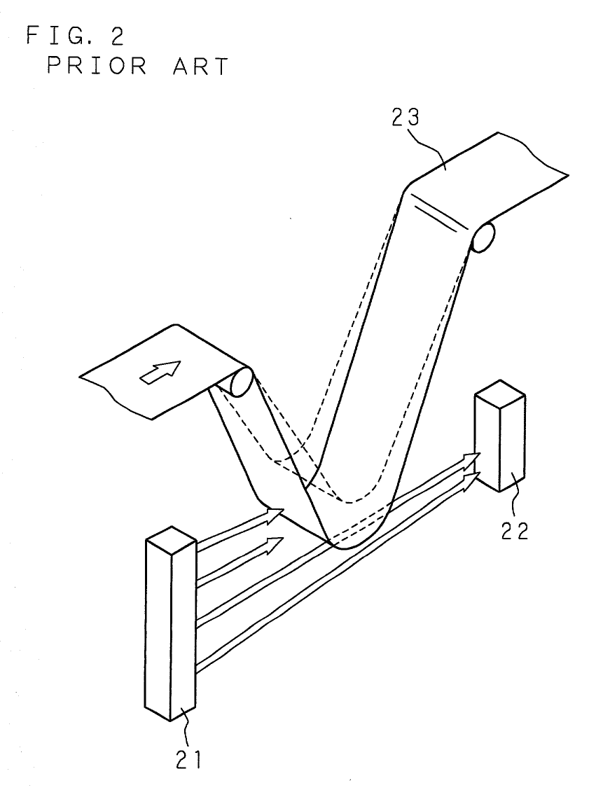

FIG. 3 is a perspective view showing still another conventional light sensor;

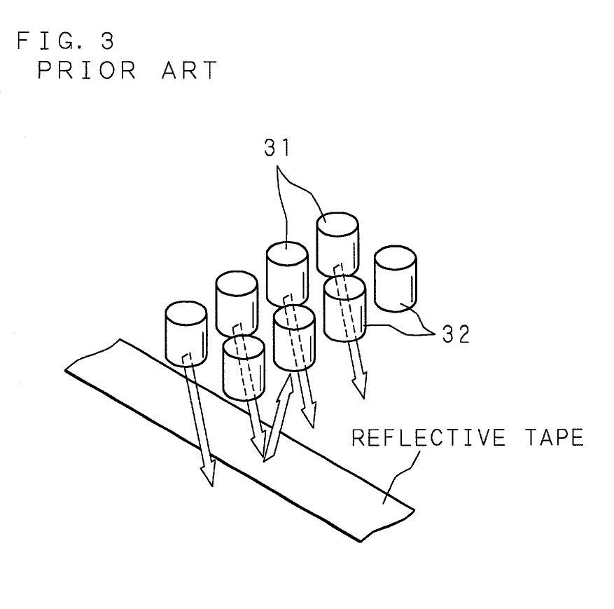

FIG. 4 is a perspective view showing the structure of a light sensor according to a first embodiment of the present invention;

FIG. 5 is a perspective view schematically showing the structure of the light sensor according to the first embodiment of the present invention;

FIG. 6 is a perspective view schematically showing the structure of a light sensor according to a second embodiment of the present invention;

FIG. 7 is a schematic view explaining the operation of the light sensor according to the second embodiment of the present invention;

FIG. 8 is a perspective view showing the structure of a light sensor according to a third embodiment of the present invention;

FIG. 9 is a perspective view schematically showing the structure of the light sensor according to the third embodiment of the present invention;

FIG. 10 is a perspective view showing the structure of a light sensor according to a fourth embodiment of the present invention; and

FIG. 11 is a perspective view schematically showing the structure of the light sensor according to the fourth embodiment of the present invention.

### DETAILED DESCRIPTION OF THE INVENTION

Hereinafter, the present invention will be concretely described with reference to drawings showing embodiments thereof.

Embodiment 1

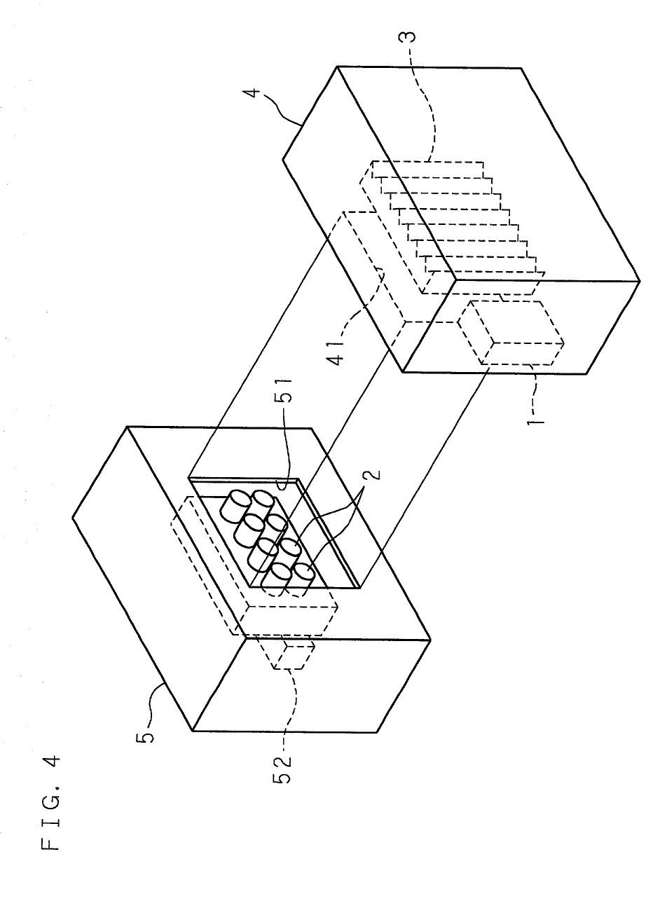

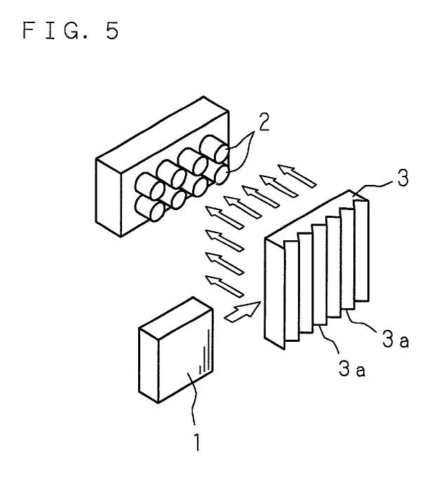

FIG. 4 is a perspective view showing the structure of a light sensor according to a first embodiment of the present invention. FIG. 5 is a perspective view schematically showing the structure of the light sensor according to the first embodiment of the present invention.

A light emitter 1 and an angular-plate-shaped light guide 3 are disposed in a box-shaped casing 4 with the light emitting face of the light emitter 1 opposed to one end face of the light guide 3. A quadrangular light-transmitting window 41 having substantially the same dimensions as those of a plane of the light guide 3 is provided in the center of one side face of the casing 4. The light guide 3 is situated so that one plane thereof faces the light-transmitting window 41.

Light receivers 2 are disposed in a casing 5 having substantially the same shape as that of the casing 4. A light-transmitting window 51 having substantially the same dimensions as those of the light-transmitting window 41 is provided on one side face of the casing 5. The casing 5 is situated at an appropriate distance from the casing 4 so that the side face thereof where the light transmitting window 51 is provided is opposed to the side face of the casing 4 where the light transmitting window 41 is provided. The light receivers 2 are attached to an angular-plate-shaped mount parallel to the light-transmitting window 51 so that the light receiving faces thereof face the light-transmitting window 51, and are disposed in the casing 5.

Thus, one plane (hereinafter, referred to as light ejecting face) of the light guide 3 is opposed to the light receiving faces of the light receivers 2 with the light transmitting windows 41 and 51 in between.

As shown in FIG. 4, a controller 52 incorporating an MPU, a ROM, a RAM and the like is disposed in the casing 5. A cable (not shown) extending from the light receivers 2 is connected to the controller 52. Through this cable, electric signals outputted from the light receivers 2 can be inputted to the controller 52.

The light receivers 2 each generate an output voltage (electric signal) responsive to the light reception quantity. That is, the light receivers 2 each have an output characteristic such that the output voltage is zero when the light reception quantity is zero and the output voltage increases as the light reception quantity increases.

The controller 52 stores a preset threshold value in the ROM or the RAM. A program is stored in the ROM of the controller 52. By the MPU executing the program, the MPU can determine whether the output voltage of each light receiver 2 is higher than the threshold value or not. When the output voltages of all the light receivers 2 are higher than the threshold value, it is presumed that no object has entered the space (detection range) between the light receivers 2 and the light guide 3. When the output voltage of one or more of the light receivers 2 is equal to or lower than the threshold value, it is presumed that an object has entered the detection range. The electric signal responsive to the determination is outputted from the controller 52 to an external apparatus (not shown) for controlling, for example, a robot.

While in the first embodiment, a threshold value is preset and the output voltages of the light receivers 2 are compared with the threshold value to thereby detect entry of an object into the detection range, the present invention is not limited thereto. In addition thereto, for example, it may be performed to store a threshold value different from the above-mentioned threshold value in the ROM or the RAM and calculate the differentiation values of the output voltages of the light receivers 2 by the MPU. In this case, the differentiation values are compared with the threshold value. When all the differentiation values are lower than the threshold value, it is presumed that no object has entered the detection range. When one or more of the differentiation values are equal to or higher than the threshold value, it is presumed that an object has entered the detection range.

The light guide 3 is made of an inorganic material such as transparent glass or an organic material such as acrylic or polycarbonate. On the plane of the light guide 3 which is opposite to the light ejecting face, a plurality of reflection portions 3a each comprising a V groove parallel to the end face and having a predetermined angle of inclination are continuously arranged in a direction perpendicular to the end face.

In the light guide 3, the light taken in through the end face opposed to the light emitter 1 is reflected at portions including the reflection portions 3a, and is ejected from the light ejecting face with the luminous flux divergent. The inclination angle of the inclined surfaces of the reflection portions 3a is such that the light reflected at the inclined surfaces is ejected from the light ejecting face substantially vertically to the light ejecting face. The light ejected from the light guide 3 is received by the light receivers 2.

In this light sensor, since the range in which the light receivers 2 can receive the light emitted from one light emitter 1 is increased, the range of detection by the light sensor for detecting entry of an object can be increased.

Moreover, by disposing the light emitting face of the light emitter 1 and the end face of the light guide 3 so as to be opposed to each other or by bonding the light emitting face and the end face together, it is facilitated to make the optical axes coincide with each other, so that the maintenance and management cost of the optical axis adjustment can be reduced.

Furthermore, since the light guide 3 has a plate shape, only a small space for placement is required.

The end face of the light guide 3 which is opposite to the side receiving the light from the light emitter 1 and the side faces of the light guide 3 may be covered with white tape or the like so that light is ejected only from the light ejecting face.

While in the first embodiment, a plurality of reflection portions 3a each comprising a V groove parallel to the end face of the light guide 3 is continuously arranged in the direction perpendicular to the end face, the present invention is not limited thereto. In addition thereto, for example, the reflection portions 3 may have a different shape such as a U groove. Moreover, the reflection portions 3a may be arranged so as to be spaced at a predetermined distance. Furthermore, the reflection portions 3a may be arranged in a direction inclined at a predetermined angle from a direction perpendicular to the end face.

By changing the angle of the incident light from the light emitter 1 to the end face of the light guide 3, the angle of inclination of the reflection portions 3a, the distance between the reflection portions 3a and the angle of the reflection portions 3a to the end face of the light guide 3, the angle of the light ejected from the light ejecting face of the light guide 3 can be arbitrarily changed in accordance with the positional relationship between the light emitter 1, the light receivers 2 and the light guide 3.

While in the first embodiment, the reflection portions 3a each comprise a V groove provided so as to connect the opposed sides of the plane of the light guide 3, the present invention is not limited thereto. In addition thereto, for example, a plurality of V grooves shorter than the opposed sides may be linearly arranged between the opposed sides so as to be spaced at a predetermined distance.

Moreover, for example, a white sheet may be bonded to the surface of each reflection portion 3a to prevent light from leaking outside from this part. Furthermore, for example, an aluminum alloy may be evaporated on the surface of each reflection portion 3a so that the reflectivity of the reflection portions 3a further improves.

While in the first embodiment, the reflection portions 3a are continuously arranged with no distance between the adjoining reflection portions 3a, the present invention is not limited thereto. In addition thereto, for example, the distance between the adjoining reflection portions 3a may be decreased with distance from the incident-side end face of the light guide 3 so that the number of reflection portions 3a increases with distance from the end face. Since the quantity of light passing through the light guide 3 decreases with distance from the incident-side end face of the light guide 3, the quantity of the ejected light can be made substantially uniform over the entire area of the light ejecting face of the light guide 3.

Moreover, the light guide 3 may have a structure such that, for example, a white tape is bonded to the end face opposed to the incident-side end face so that the light received at the opposed end face is reflected toward the inside of the light guide, the distance between the adjoining reflection portions 3a is small in a middle part of the light guide 3 and the distance between the adjoining reflection portions 3a is large in both end parts of the light guide 3. Consequently, the number of reflection portions 3a is small in both end parts of the light guide 3 where the quantity of the passing light is large, and the number of reflection portions 3a is large in the middle part of the light guide 3 where the quantity of the passing light is small. As a result, the quantity of the ejected light can be made substantially uniform over the entire area of the light ejecting face of the light guide 3.

While in the first embodiment, the reflection portions 3a each comprise a V groove parallel to the end face of the light guide 3, the present invention is not limited thereto. In addition thereto, for example, reflection portions 3a comprising V grooves inclined at a predetermined angle to the end face of the light guide 3 and V grooves inclined in a direction opposite to the above V grooves may be provided so that these two kinds of V grooves are arranged alternately.

While the reflection portions 3a each comprise a V groove in the first embodiment, the present invention is not limited thereto. In addition thereto, for example, a plurality of reflection portions 3a each comprising a quadrangular-pyramid-shaped protrusion may be provided on a plane of the light guide 3. Moreover, a plurality of reflection portions 3a each comprising a conical hole may be provided on a plane of the light guide 3.

Moreover, a plurality of belt-shaped reflection portions 3a may be provided on a plane of the light guide 3, for example, by printing a white light diffusible agent on the plane or by bonding a white light diffusible sheet to the plane. This light guide 3 may be structured so that, in order that the quantity of the ejected light is substantially uniform over the entire area of the light ejecting face of the light guide 3, for example, the width of the reflection portion 3a increases and the distance between the adjoining reflection portions 3a decreases with distance from the incident-side end face. Moreover, for example, the reflection portions 3a may cover the entire area of a plane of the light guide 3.

Furthermore, particles made of a transmittable material having a refractive index different from that of the material of the light guide 3 may be scattered in the light guide 3, and reflection portions 3d formed, for example, by applying a white reflective agent or bonding a white reflective sheet may be provided on a plane of the light guide 3. In this light guide 3, when the light taken in the light guide 3 impinges on a particle, the light is diffused. The diffused light is further diffused by another particle. Light is propagated while such a diffusion is repeated, and is ejected from the light ejecting face.

While the angular-plate-shaped light guide 3 is employed in the first embodiment, the present invention is not limited thereto. In addition thereto, for example, a plate-shaped light guide 3 whose cross section is curved in a C shape, a bar-shaped light guide 3 having a polygonal cross section, or a round-bar-shaped light guide 3 may be employed.

Embodiment 2

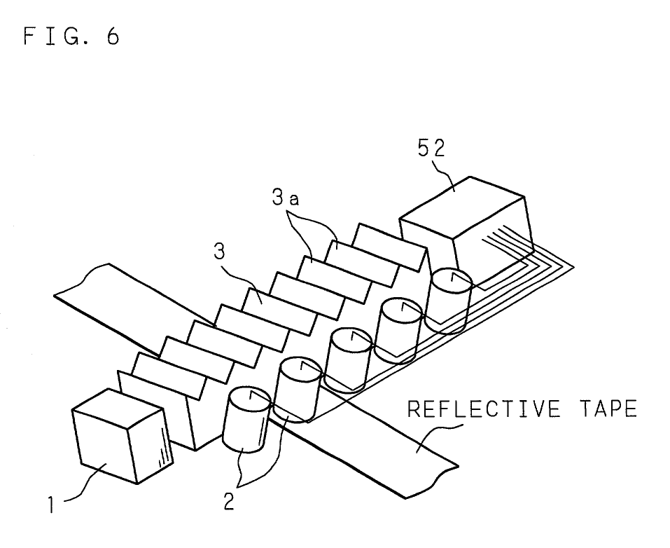

FIG. 6 is a perspective view schematically showing the structure of a light sensor according to a second embodiment of the present invention. A bar-shaped light guide 3 having a quadrangular cross section is disposed so as to be laterally elongated and so that the bottom face thereof is inclined at a predetermined angle to the horizontal plane. A light emitter 1 is disposed so that one end face of the light guide 3 and the light emitting face of the light emitter 1 are opposed to each other. At a side of the light guide 3, a plurality of light receivers 2 are arranged in a line so as to be parallel to the light guide 3. The light receivers 2 are disposed with the light receiving faces thereof facing downward, more specifically, with the light receiving faces thereof slightly inclined from the horizontal toward the light guide 3.

A controller 52 incorporating an MPU, a ROM, a RAM and the like is disposed in the vicinity of the light receivers 2. A cable extending from the light receivers 2 is connected to the controller 52. Through this cable, electric signals outputted from the light receivers 2 can be inputted to the controller 52.

The light receivers 2 each generate an output voltage (electric signal) responsive to the light reception quantity. That is, the light receivers 2 each have an output characteristic such that the output voltage is zero when the light reception quantity is zero and the output voltage increases as the light reception quantity increases.

The controller 52 stores a preset threshold value in the ROM or the RAM. A program is stored in the ROM of the controller 52. By the MPU executing the program, the MPU can determine whether the output voltage of each light receiver 2 is higher than the threshold value or not. When the output voltage of one or more of the light receivers 2 is higher than the threshold value, it is presumed that an object reflecting light (reflective object) is present below this light receiver or these light receivers 2. When the output voltage of one or more of the light receivers 2 is equal to or lower than the threshold value, it is presumed that no reflective object is present below this light receiver or these light receivers 2. The electric signal responsive to the determination is outputted from the controller 52 to an external apparatus (not shown) for controlling, for example, a conveyer vehicle.

The light guide 3 is made of an inorganic material such as transparent glass or an organic material such as acrylic or polycarbonate. On the top face of the light guide 3, a plurality of reflection portions 3a each comprising a V groove parallel to the end face and having a predetermined angle of inclination are continuously arranged in a direction perpendicular to the end face.

Such a light sensor is, for example, attached to a conveyer vehicle (not shown) for conveying articles in a factory or a warehouse. In this case, onto the floor of the factory or the warehouse, for example, a white reflective tape is bonded along the conveyance path of the conveyer vehicle. Here, the floor of the factory or the warehouse is of a color different from white.

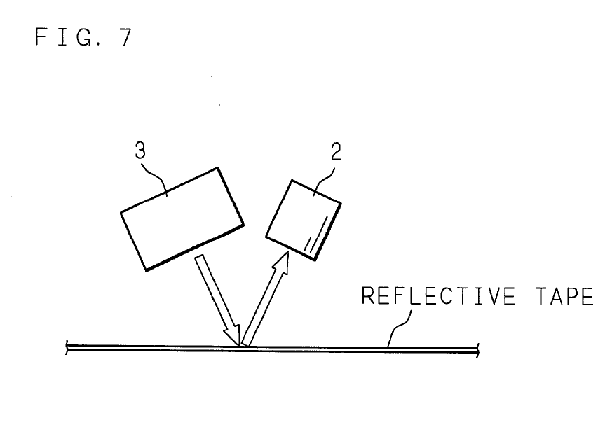

FIG. 7 is a schematic view explaining the operation of the light sensor according to the second embodiment of the present invention. The light sensor is attached to a conveyer vehicle so as to be a predetermined distance away from the floor. Light emitted from the light emitter 1 is taken in the light guide 3 through the end face of the light guide 3, is reflected at portions including the reflection portions 3a, and is ejected from the bottom face (light ejecting face) with the luminous flux divergent. The inclination angle of the inclined surfaces of the reflection portions 3a is such that the light reflected at the inclined surfaces is ejected from the light ejecting face substantially vertically to the light ejecting face.

The light thus ejected from the light guide 3 is applied to the floor. Of the light applied to the floor, light applied to the part where the reflective tape is bonded is mostly mirror-reflected by the reflective tape and received by one or more of the light receivers 2 opposed to the reflective tape. On the other hand, light applied to the part of the floor where no reflective tape is bonded is mostly irregularly reflected at the floor, so that the light receivers 2 opposed to the part of the floor where no reflective tape is bonded receive hardly any light.

While in the second embodiment, the bar-shaped light guide 3 having the groove-shaped reflection portions 3a and having the quadrangular cross section is employed, like the first embodiment, the present invention is not limited thereto.

Embodiment 3

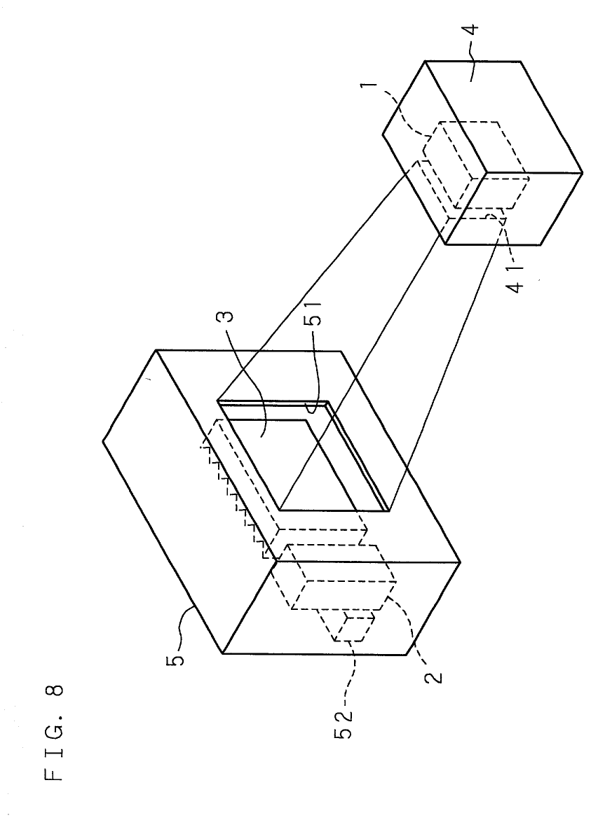

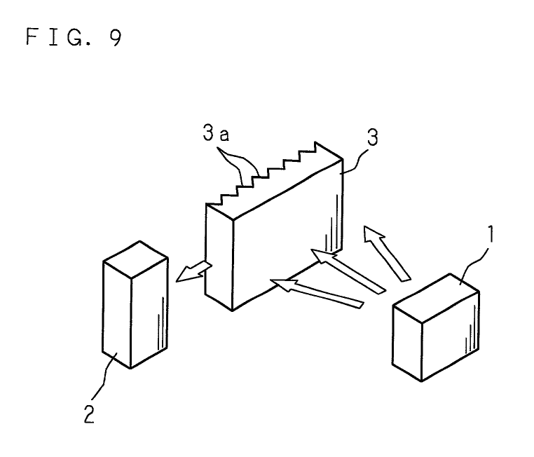

FIG. 8 is a perspective view showing the structure of a light sensor according to a third embodiment of the present invention. FIG. 9 is a perspective view schematically showing the structure of the light sensor according to the third embodiment of the present invention.

As shown in FIG. 8, in a box-shaped casing 4, a light emitter 1 is disposed so that the light emitting face thereof is opposed to a quadrangular light transmitting window 41 provided in the center of one side face of the casing 4.

A box-shaped casing 5 larger than the casing 4 is disposed at an appropriate distance from the casing 4 so as to be opposed to the light-transmitting window 41 of the casing 4. A quadrangular light-transmitting window 51 larger than the light-transmitting window 41 is provided on a face of the casing 5 which is opposed to the light-transmitting window 41.

In the casing 5, a light guide 3 is disposed so that one plane thereof (hereinafter, referred to as light receiving face) faces the light-transmitting window 51. The plane of the light guide 3 has substantially the same dimensions as those of the light-transmitting window 51. Thus, the light emitting face of the light emitter 1 and the light receiving face of the light guide 3 are opposed to each other with the light transmitting windows 41 and 51 in between. At a side of the light guide 3, a light receiver 2 is disposed so that the light receiving face thereof is opposed to an end face of the light guide 3.

In the casing 5, a controller 52 incorporating an MPU, a ROM, a RAM and the like is disposed. A cable (not shown) extending from the light receiver 2 is connected to the controller 52. Through this cable, an electric signal outputted from the light receiver 2 can be inputted to the controller 52.

The light receiver 2 generates an output voltage (electric signal) responsive to the light reception quantity. That is, the light receiver 2 has an output characteristic such that the output voltage is zero when the light reception quantity is zero and the output voltage increases as the light reception quantity increases.

The controller 52 stores a preset threshold value in the ROM or the RAM. A program is stored in the ROM of the controller 52. By the MPU executing the program, the MPU can determine whether the output voltage of the light receiver 2 is higher than the threshold value or not. When the output voltage of the light receiver 2 is higher than the threshold value, it is presumed that no object has entered the space (detection range) between the light emitter 1 and the light guide 3. When the output voltage of the light receiver 2 is equal to or lower than the threshold value, it is presumed that an object has entered the detection range. The electric signal responsive to the determination is outputted from the controller 52 to an external apparatus (not shown) for controlling, for example, a robot.

While in the third embodiment, a threshold value is preset and the output voltage of the light receiver 2 is compared with the threshold value to thereby detect entry of an object into the detection range, the present invention is not limited thereto. In addition thereto, for example, it may be performed, to store a threshold value different from the above-mentioned threshold value in the ROM or the RAM and calculate the differentiation value of the output voltage of the light receiver 2 by the MPU. In this case, the differentiation value is compared with the threshold value. When the differentiation value is lower than the threshold value, it is presumed that no object has entered the detection range. When the differentiation value is equal to or higher than the threshold value, it is presumed that an object has entered the detection range.

Since the structure of the light guide 3 of the third embodiment is the same as that of the light guide 3 of the first embodiment except that the face of the light guide 3 which is used as the light ejecting face in the first embodiment is used as the light receiving face in the third embodiment, the same members are designated by the same reference numerals and the descriptions thereof are omitted.

As shown in FIG. 9, from the light emitting face of the light emitter 1, light is emitted so as to diverge with distance from the light emitter 1, and most of the light is taken in the light guide 3 through the light receiving face of the light guide 3. The taken-in light is reflected at portions including the reflection portions 3a of the light guide 3, and is ejected from the end face on the side of the light receiver 2. The inclination angle of the inclined surfaces of the reflection portions 3a is such that the light reflected at the inclined surfaces is ejected from the end face substantially vertically to the end face. The light ejected from the light guide 3 is received by the light receiver 2.

In the light sensor of the third embodiment, since the range in which one light receiver 2 can receive light is increased, the range of detection by the light sensor for detecting entry of an object can be increased.

Moreover, by disposing the light receiving face of the light receiver 2 and the end face of the light guide 3 so as to be opposed to each other or by bonding the light receiving face and the end face together, it is facilitated to make the optical axes coincide with each other, so that the maintenance and management cost of the optical axis adjustment can be reduced.

Furthermore, since the light guide 3 has a plate shape, only a small space for placement is required.

While in the third embodiment, the plate-shaped light guide 3 having the groove-shaped reflection portions 3a is employed, like the first embodiment, the present invention is not limited thereto.

Embodiment 4

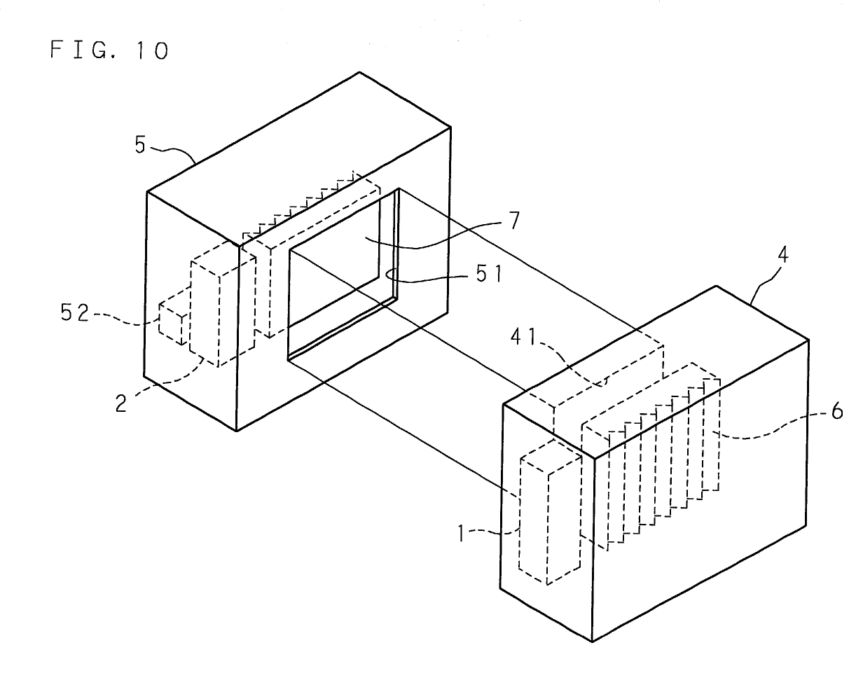

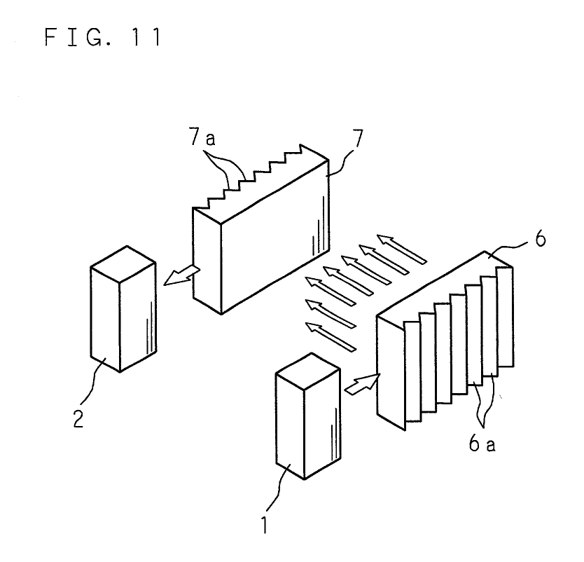

FIG. 10 is a perspective view showing the structure of a light sensor according to a fourth embodiment of the present invention. FIG. 11 is a perspective view schematically showing the structure of the light sensor according to the fourth embodiment of the present invention.

As shown in FIG. 10, on one side face of a box-shaped casing 4, a quadrangular light-transmitting window 41 having substantially the same dimensions as those of the plane of a first light guide 6 is provided. In the casing 4, the first light guide 6 having an angular plate shape is disposed with one plane (light ejecting face) thereof opposed to the light-transmitting window 41. The light emitter 1 is disposed with the light emitting face thereof opposed to one end face of the first light guide 6.

A light receiver 2 and an angular-plate-shaped second light guide 7 are disposed in a casing 5 having substantially the same shape as that of the casing 4. On one side face of the casing 5, a light-transmitting window 51 having substantially the same dimensions as those of the light-transmitting window 41 is provided. The casing 5 is situated at an appropriate distance from the casing 4 so that the side face thereof where the light transmitting window 51 is provided is opposed to the side face of the casing 4 where the light transmitting window 41 is provided. The second light guide 7 is disposed with one plane (light receiving face) thereof opposed to the light-transmitting window 51. The light receiver 2 is disposed with the light receiving face thereof opposed to one end face of the second light guide 7.

In the casing 5, a controller 52 incorporating an MPU, a ROM, a RAM and the like is disposed. A cable (not shown) extending from the light receiver 2 is connected to the controller 52. Through this cable, an electric signal outputted from the light receiver 2 can be inputted to the controller 52.

The light receiver 2 generates an output voltage (electric signal) responsive to the light reception quantity. That is, the light receiver 2 has an output characteristic such that the output voltage is zero when the light reception quantity is zero and the output voltage increases as the light reception quantity increases.

The controller 52 stores a preset threshold value in the ROM or the RAM. A program is stored in the ROM of the controller 52. By the MPU executing the program, the MPU can determine whether the output voltage of the light receiver 2 is higher than the threshold value or not. When the output voltage of the light receiver 2 is higher than the threshold value, it is presumed that no object has entered the space (detection range) between the first light guide 6 and the second light guide 7. When the output voltage of the light receiver 2 is equal to or lower than the threshold value, it is presumed that an object has entered the detection range. The electric signal responsive to the determination is outputted from the controller 52 to an external apparatus (not shown) for controlling, for example, a robot.

While in the fourth embodiment, a threshold value is preset and the output voltage of the light receiver 2 is compared with the threshold value to thereby detect entry of an object into the detection range, the present invention is not limited thereto. In addition thereto, for example, it may be performed to store a threshold value different from the above-mentioned threshold value in the ROM or the RAM and calculate the differentiation value of the output voltage of the light receiver 2 by the MPU. The differentiation value is compared with the threshold value. When the differentiation value is lower than the threshold value, it is presumed that no object has entered the detection range. When the differentiation value is equal to or higher than the threshold value, it is presumed that an object has entered the detection range.

Since the structure of the first light guide 6 of the fourth embodiment is the same as that of the light guide 3 of the first embodiment, the description thereof is omitted.

Moreover, since the structure of the second light guide 7 of the fourth embodiment is the same as that of the light guide 3 of the first embodiment except that the face of the light guide which is used as the light ejecting face in the first embodiment is used as the light receiving face in the fourth embodiment, the description thereof is omitted.

As shown in FIG. 11, light emitted from the light emitter 1 is taken in the first light guide 6 through an end face of the first light guide 6. The taken-in light is reflected at portions including reflection portions 6a of the first light guide 6, and is ejected from the light ejecting face of the first light guide 6 with the luminous flux divergent. The inclination angle of the inclined surfaces of the reflection portions 6a is such that the light reflected at the inclined surfaces is ejected from the light ejecting face substantially vertically to the light ejecting face.

The light ejected from the first light guide 6 is mostly taken in the second light guide 7 through the light receiving face of the second light guide 7, is reflected at portions including reflection portions 7a of the second light guide 7, and is ejected from the end face of the second light guide 7 which faces the light receiver 2. The inclination angle of the inclined surfaces of the reflection portions 7a is such that the light reflected at the inclined surfaces is ejected from the end face substantially vertically to the end face. The light ejected from the second light guide 7 is received by the light receiver 2.

In the light sensor of the fourth embodiment, since the range in which one light receiver 2 can receive the light emitted from one light emitter 1 is increased, the range of detection by the light sensor for detecting entry of an object can be increased.

Moreover, by disposing the light emitting face of the light emitter 1 and the end face of the first light guide 6 so as to be opposed to each other or bonding the light emitting face and the end face together, or by disposing the light receiving face of the light receiver 2 and the end face of the second light guide 7 so as to be opposed to each other or bonding the light receiving face and the end face together, it is facilitated to make the optical axes coincide with each other, so that the maintenance and management cost of the optical axis adjustment can be reduced.

Furthermore, since the first and the second light guides 6 and 7 have a plate shape, only a small space for placement is required.

While in the fourth embodiment, the plate-shaped first light guide 6 having the groove-shaped reflection portions 6a is employed, like the first embodiment, the present invention is not limited thereto.

Moreover, while in the fourth embodiment, the plate-shaped second light guide 7 having the groove-shaped reflection portions 7a is employed, like the first embodiment, the present invention is not limited thereto.

To the light guides used in the light sensor according to the present invention, for example, a luminance enhancing film sold with a product name “VIKUITI” by Sumitomo 3M Inc. may be bonded. By doing this, the quantity of the light ejected substantially parallelly from the light ejecting face can be further increased.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A light sensor comprising:
a light emitter;
a light receiver for receiving light emitted from said light emitter; and
a light guide for taking in the light emitted from the light emitter, reflecting the taken-in light at a reflection portion provided on a part thereof, and ejecting the light toward the light receiver,
wherein the light receiver and the light guide are disposed so as to be opposed to each other with an appropriate space in between, and entry of an object into said space is detected based on the light received by the light receiver.

2. The light sensor according to claim 1, wherein the light guide in a plate shape, which has the reflection portion disposed on one plane thereof, takes in the light through one end face thereof, reflects the taken-in light at the reflection portion, and ejects the reflected light from the other plane thereof.

3. The light sensor according to claim 2, wherein the reflection portion has a groove shape.

4. A light sensor comprising:
a light emitter;
a light receiver for receiving light emitted from said light emitter and reflected at a reflective object; and
a light guide for taking in the light emitted from the light emitter, reflecting the taken-in light at a reflection portion provided on a part thereof, and ejecting the light,
wherein the light receiver receives the light ejected from the light guide and reflected at the reflective object, and a position of said reflective object is detected based on the light received by the light receiver.

5. The light sensor according to claim 4, wherein the light guide in a plate shape, which has the reflection portion disposed on one plane thereof, takes in the light through one end face thereof, reflects the taken-in light at the reflection portion, and ejects the reflected light from the other plane thereof.

6. The light sensor according to claim 5, wherein the reflection portion has a groove shape.

7. A light sensor comprising:
a light emitter;
a light receiver for receiving light emitted from said light emitter; and
a light guide for taking in the light emit ted from the light emitter, reflecting the taken-in light at a reflection portion provided on a part thereof, and ejecting the light toward the light receiver,
wherein the light emitter and the light guide are disposed so as to be opposed to each other with an appropriate space in between, and entry of an object into said space is detected based on the light received by the light receiver.

8. The light sensor according to claim 7, wherein the light guide in a plate shape, which has the reflection portion disposed on one plane thereof, takes in the light through one end face thereof, reflects the taken-in light at the reflection portion, and ejects the reflected light from the other plane thereof.

9. The light sensor according to claim 8, wherein the reflection portion has a groove shape.

10. A light sensor comprising:
a light emitter;
a light receiver for receiving light emitted from said light emitter;
a first light guide for taking in the light emitted from the light emitter, reflecting the taken-in light at a first reflection portion provided on a part thereof, and ejecting the light; and
a second light guide for taking in the light ejected from said first guiding body, reflecting the taken-in light at a second reflection portion provided on a part thereof, and ejecting the light toward the light receiver,
wherein the first light guide and the second light guide are disposed so as to be opposed to each other with an appropriate space in between, and entry of an object into said space is detected based on the light received by the light receiver.

11. The light sensor according to claim 10, wherein the first light guide in a plate shape, which has the first reflection portion disposed on one plane thereof, takes in the light through one end face thereof, reflects the taken-in light at the reflection portion, and ejects the reflected light from the other plane thereof.

12. The light sensor according to claim 11, wherein the first reflection portion has a groove shape.

13. The light sensor according to claim 12, wherein the second light guide in a plate shape, which has the second reflection portion disposed on one plane thereof, takes in the light through one end face thereof, reflects the taken-in light at the reflection portion, and ejects the reflected light from the other plane thereof.

14. The light sensor according to claim 13, wherein the second reflection portion has a groove shape.

15. The light sensor according to claim 10, wherein the second light guide in a plate shape, which has the second reflection portion disposed on one plane thereof, takes in the light through one end face thereof, reflects the taken-in light at the reflection portion, and ejects the reflected light from the other plane thereof.

16. The light sensor according to claim 15, wherein the second reflection portion has a groove shape.
